(19) United States
(12) Patent Application Publication
(10) Pub. No.: US 2018/0102012 A1
(43) Pub. Date: Apr. 12, 2018

(54) ELECTRONIC DOOR LOCK ASSEMBLY, AND ASSEMBLY METHOD THEREOF

(71) Applicant: Jeff Cahill, Castle Rock, CO (US)

(72) Inventor: Jeff Cahill, Castle Rock, CO (US)

(21) Appl. No.: 15/730,657

(22) Filed: Oct. 11, 2017

Related U.S. Application Data
(60) Provisional application No. 62/406,647, filed on Oct. 11, 2016.

(51) Int. Cl. G07C 9/00; E05B 47/00

(52) U.S. Cl. CPC G07C 9/00944; G07C 9/00904; G07C 2009/00642; E05B 47/0001; G07C 9/00817

(57) ABSTRACT

An electronic door lock assembly, including an outside assembly attached to a first side of a door, an inside assembly attached to a second side of a door, a cable to electrically connect the outside assembly to the inside assembly, and a raceway to secure the cable to the outside assembly.

### CROSS-REFERENCE TO RELATED APPLICATIONS

This application claims priority under 35 USC § 120 from U.S. Provisional Application No. 62/406,647, filed on Oct. 11, 2016, in the United Stated Patent and Trademark Office, the disclosure of which is incorporated herein in its entirety by reference.

### BACKGROUND OF THE INVENTION

### 1. Field of the Invention

The present general inventive concept relates to an electronic door lock, and more particularly to an electronic door lock having a simplified ribbon assembly, and assembly method thereof.

### 2. Description of the Related Art

Conventional electronic door locks have been implemented on doors to allow users to open the doors without using a metal key. Instead, a user can use a keypad, card, or other type of dongle to unlock the conventional electronic door lock, such that the user may turn a handle to successfully open the door. However, the conventional electronic door locks include cables and wiring that must be threaded through a door to electrically connect an outside portion of the assembly to an inside portion of the assembly. However, the cables and wiring are often damaged or detached when the user turns the handle, as the cables and wiring are not secured between and within the outside portion of the assembly and the inside portion of the assembly.

Therefore, there is a need for a solution to secure and protect the cables and wiring between and within the outside portion of the assembly and the inside portion of the assembly without inhibiting movement of the door handle.

### SUMMARY

The present general inventive concept provides electronic door lock having a simplified ribbon assembly.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an electronic door lock assembly, including an outside assembly attached to a first side of a door, an inside assembly attached to a second side of a door, a cable to electrically connect the outside assembly to the inside assembly, and a raceway to secure the cable to the outside assembly.

The outside assembly may include a lock chassis including the raceway, wherein the lock chassis is disposed within at least a portion of a hole in the door, a face plate comprising a proximity reader device, wherein the face plate is disposed at the first side of the door, and a printed circuit board (PCB) disposed between the face plate and the lock chassis.

The electronic door lock assembly of claim may further include a latch assembly of lock and/or lock the door, wherein the PCB controls the lock chassis to lock and/or lock the latch assembly in response to the proximity reader device reading an object in proximity thereof.

The inside assembly may further include a back plate disposed at the second side of the door, and a printed circuit board (PCB) disposed between the back plate and the second side of the door.

The cable may be connected to the PCB of the outside assembly at a first end of the cable, and the cable may be connected to the PCB of the inside assembly at a second end of the cable.

A first portion of the cable may be detachable from a second portion of the cable at a substantially center portion of the cable.

The PCB of the outside assembly may be connected to a first end of the cable such that a second end of the cable comprises one of a female connector and a male connector, and the PCB of the inside assembly may be connected to the second end of the cable with another one of the male connector and the female connector.

The PCB of the inside assembly may include pre-programmed and/or programmable information regarding various security features of the lock.

The various security features of the lock may include at least one of authorized user access, locking and/or unlocking criteria, and emergency settings.

The electronic door lock assembly may further include a raceway cover to enclose at least a portion of the cable within the raceway.

The raceway cover may be separable from the raceway.

The raceway cover may be attached to a portion of the raceway at least one of hinges and other connectors.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIGS. 1A-1D illustrate exploded views of an electronic lock assembly to be mounted on a door that is mounted onto a door frame, according to an exemplary embodiment of the present general inventive concept;

FIGS. 2A-13D illustrate various embodiments of the present general inventive concept.

### DETAILED DESCRIPTION

Various example embodiments will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like or similar elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

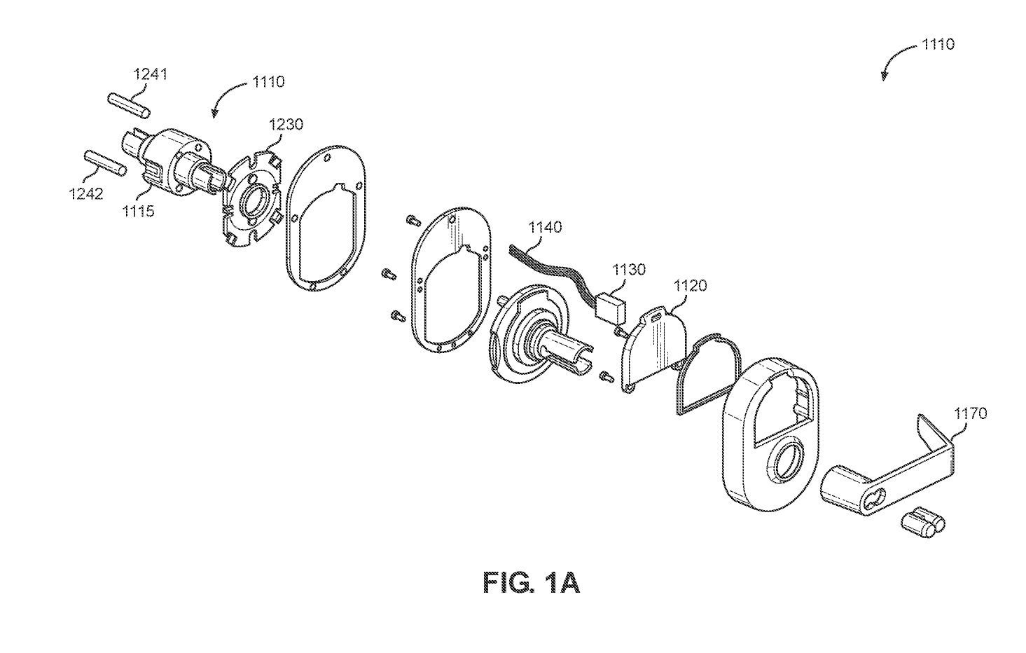

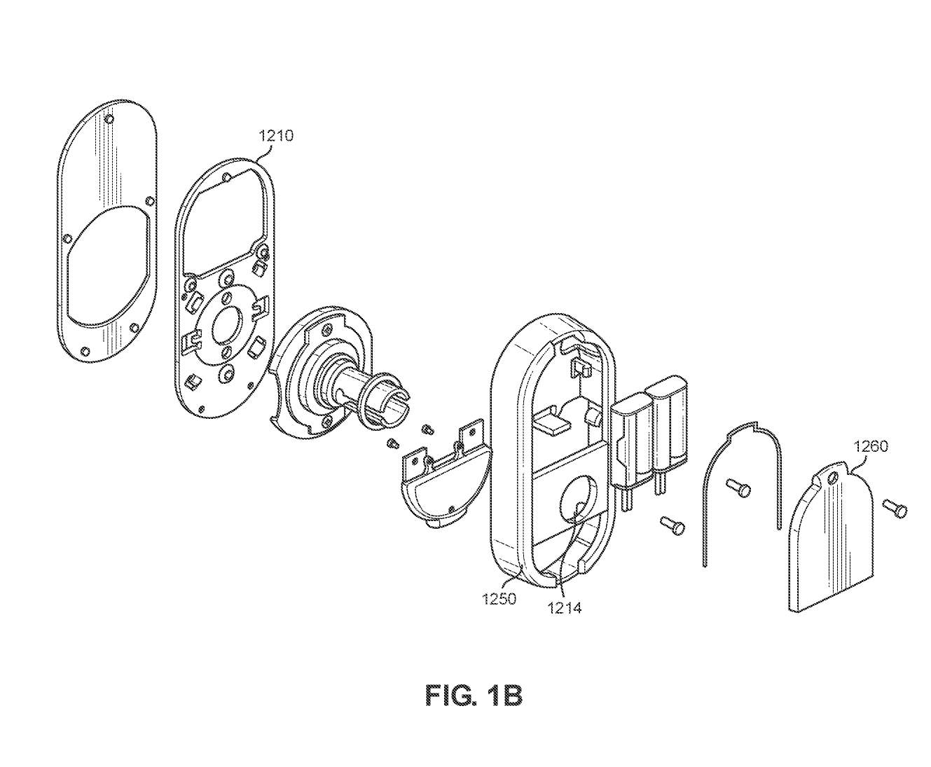

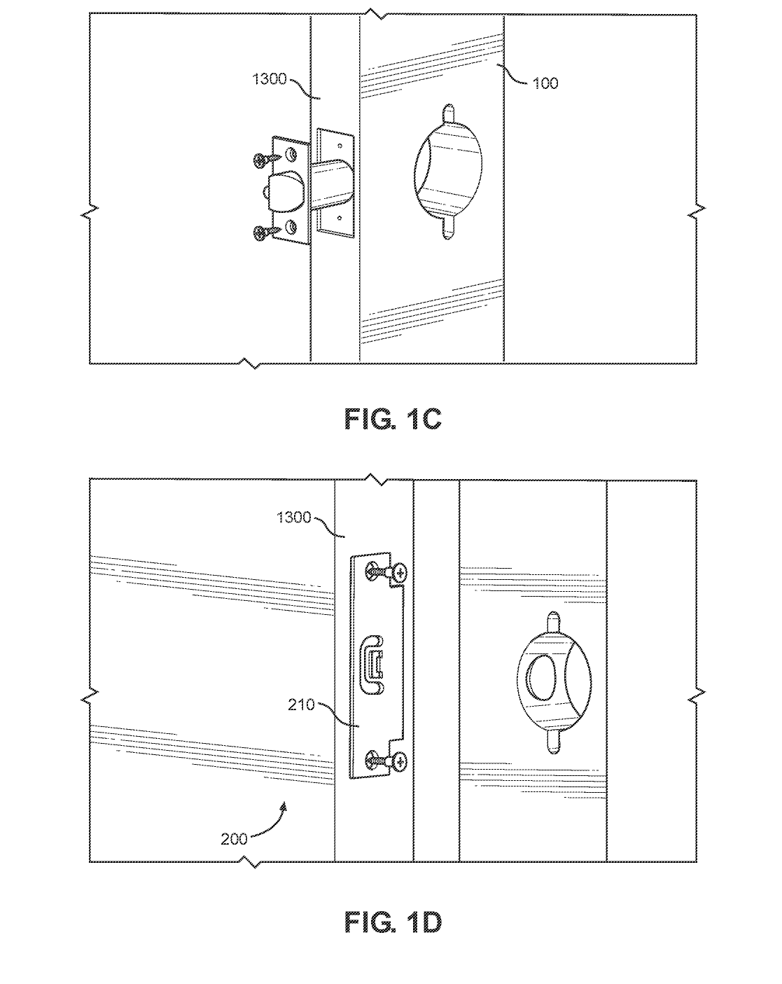

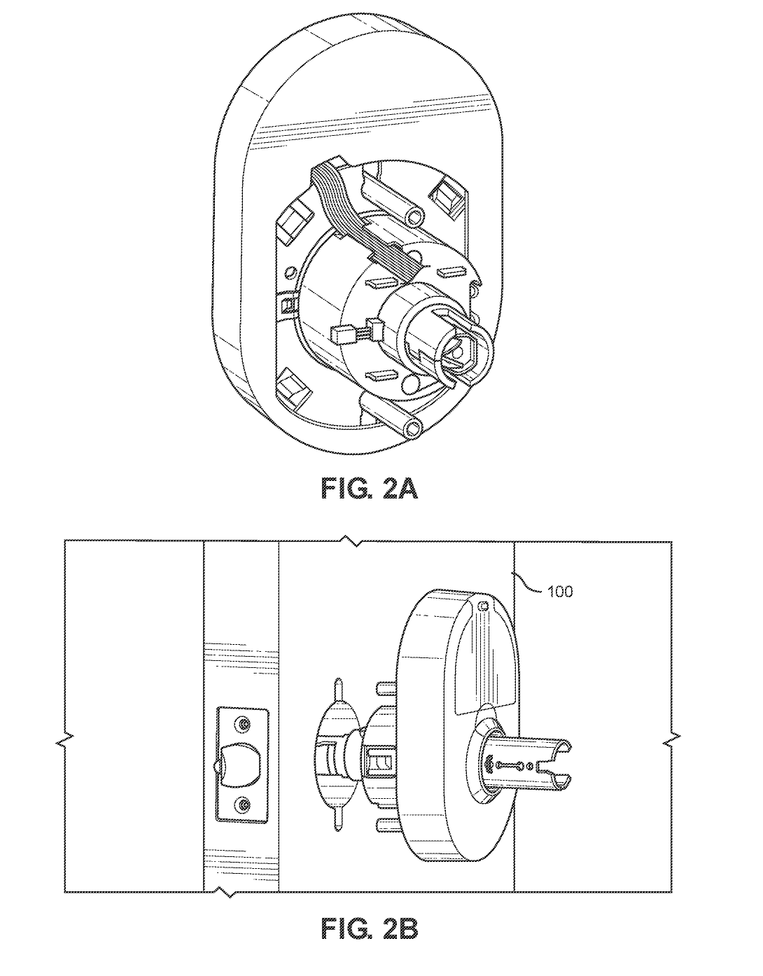

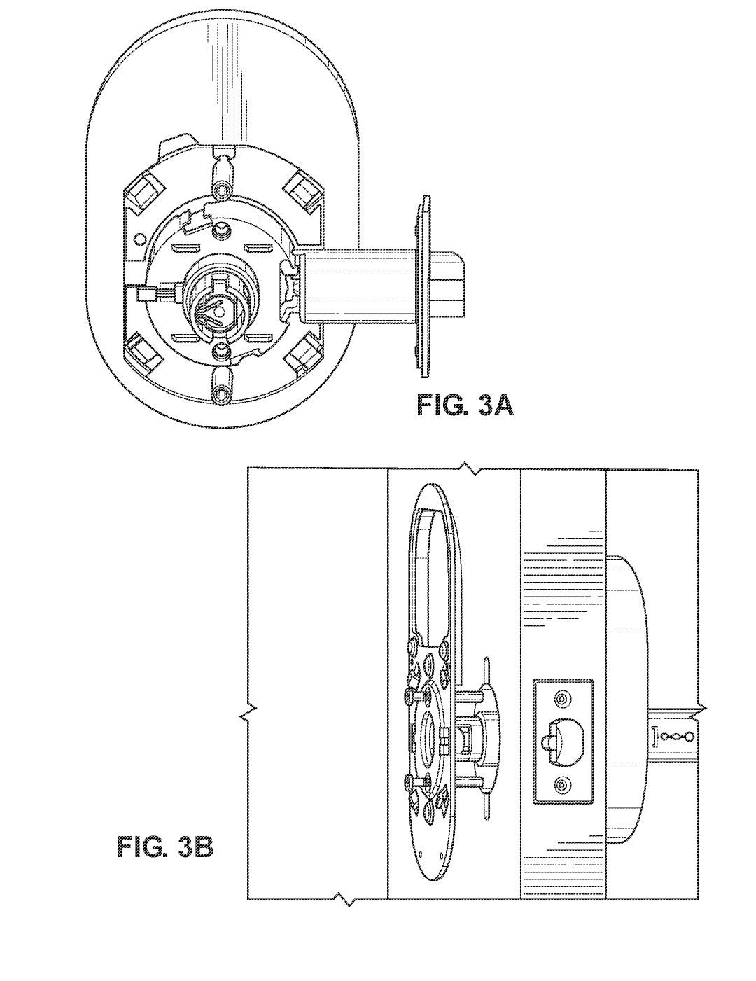

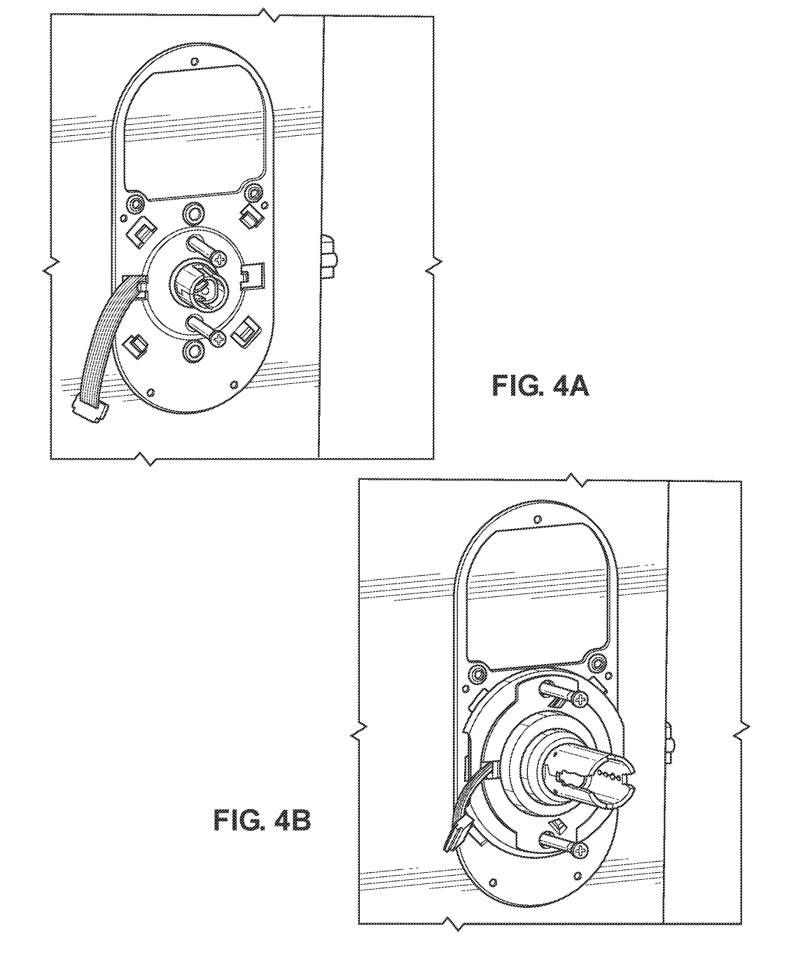

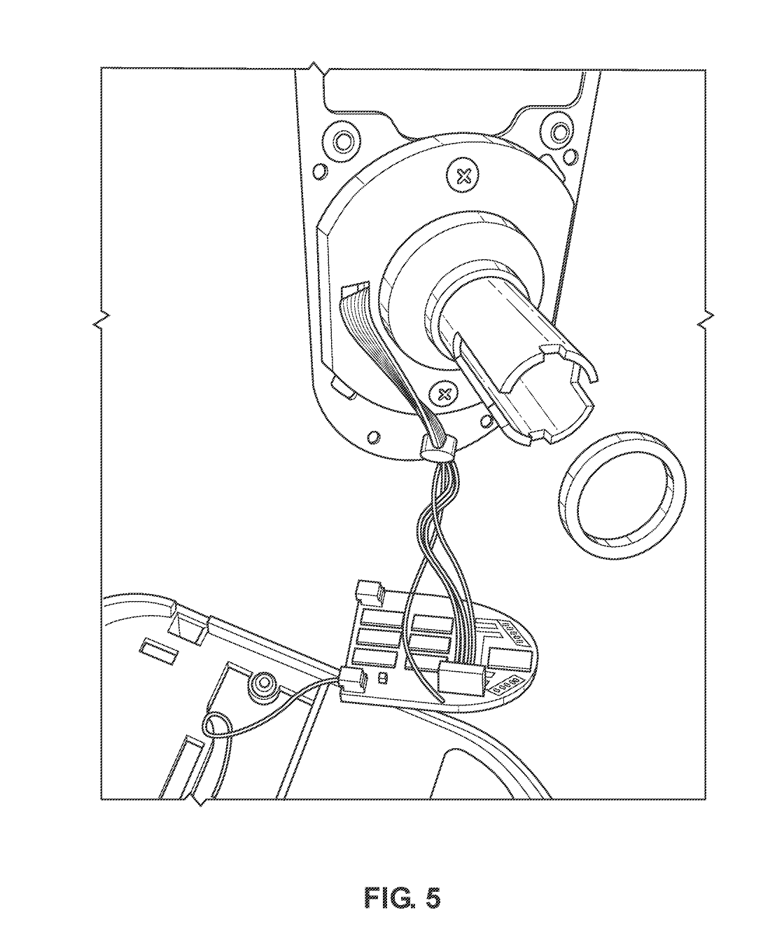

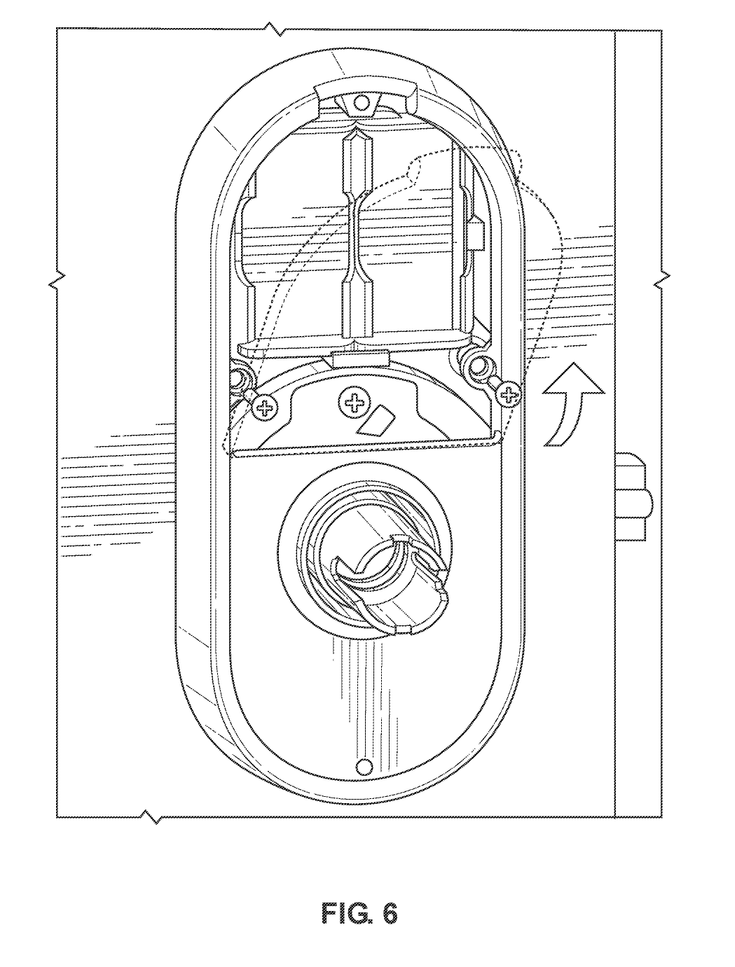

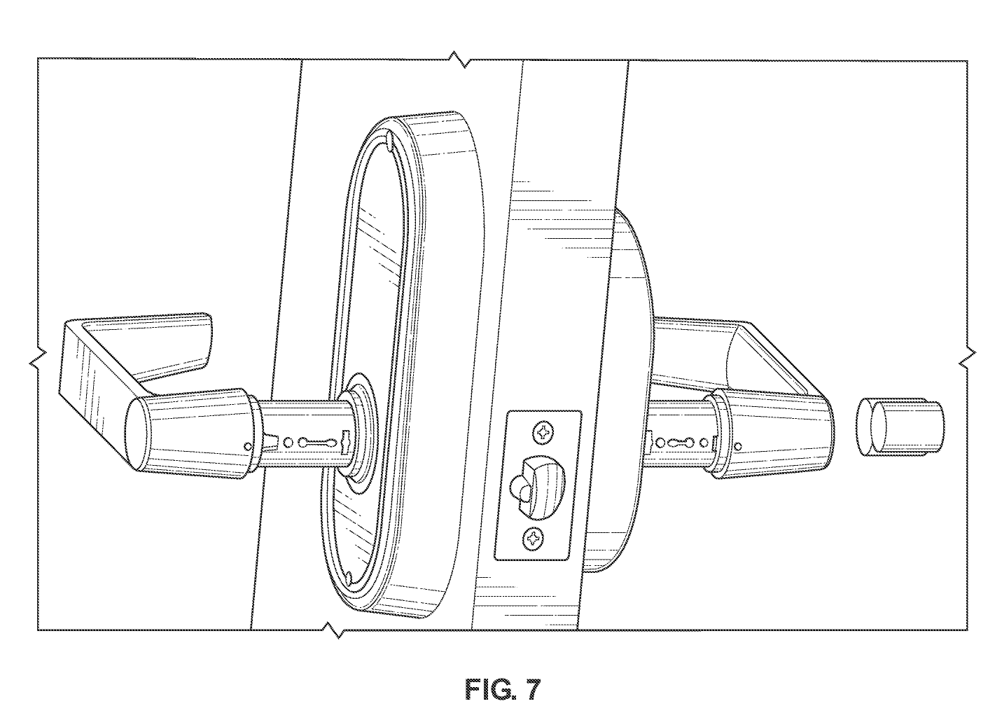

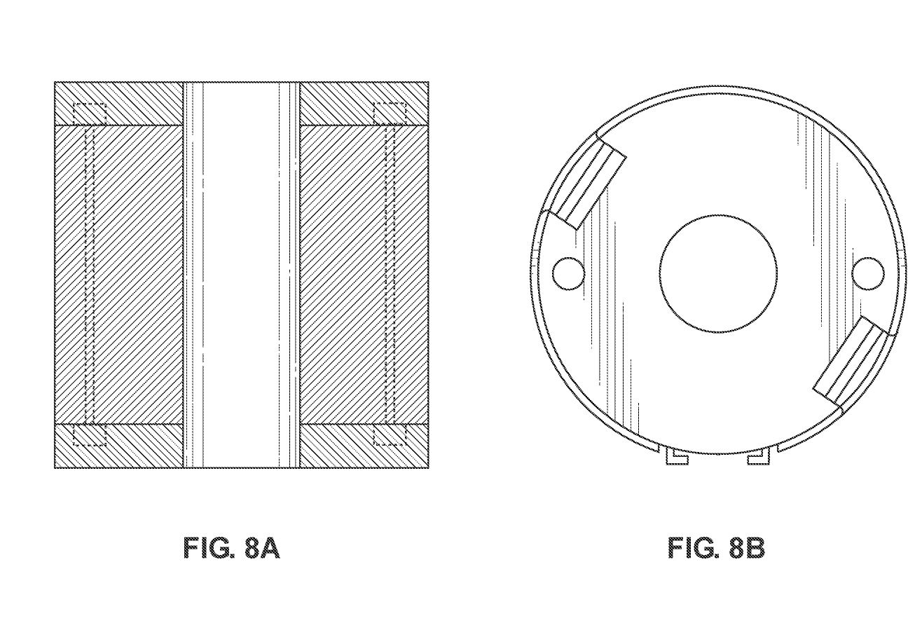

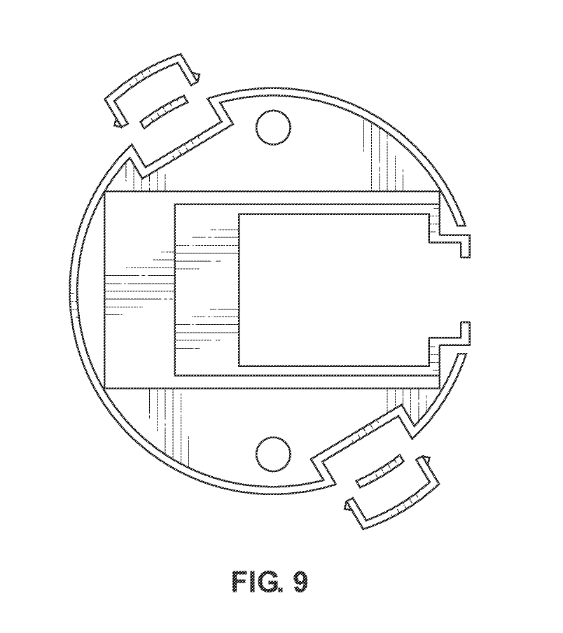

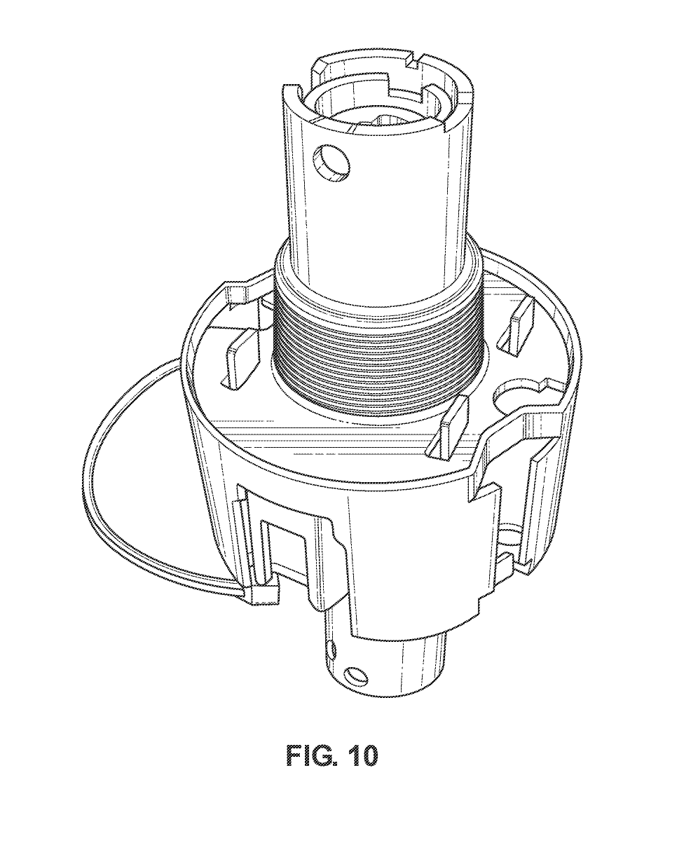

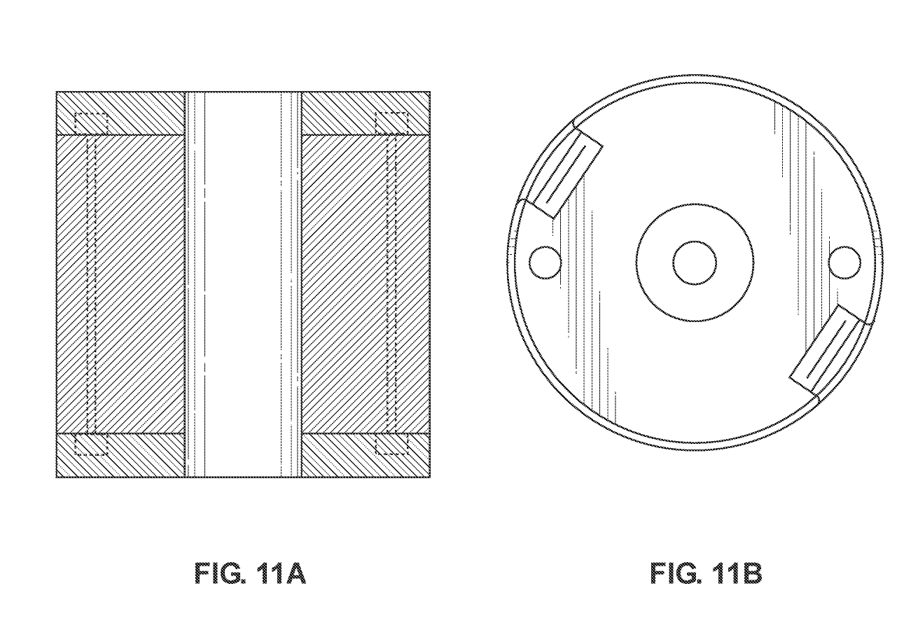

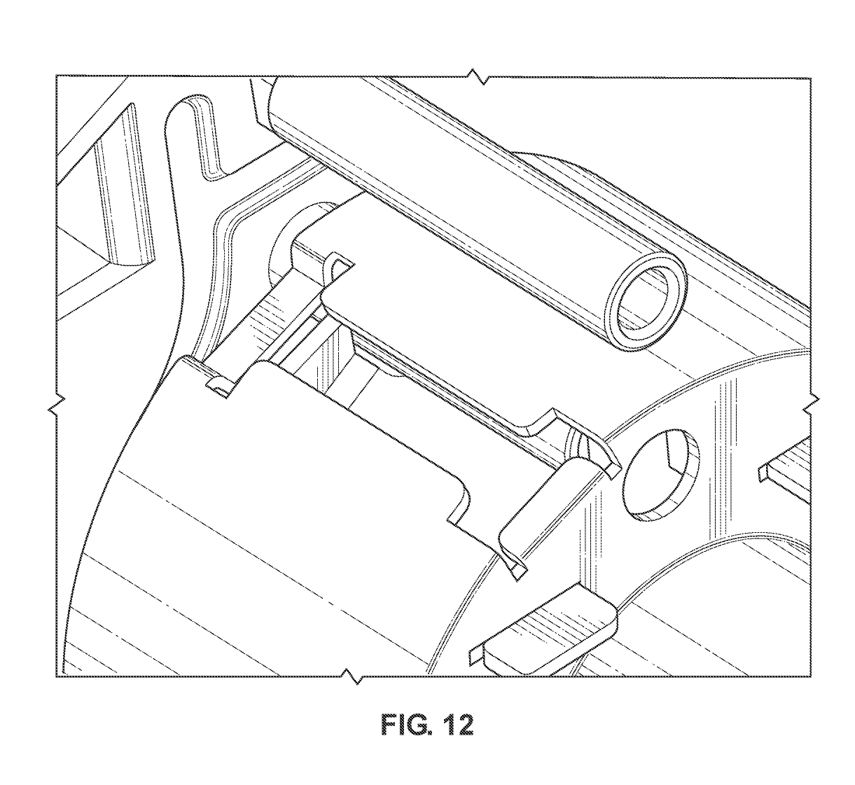

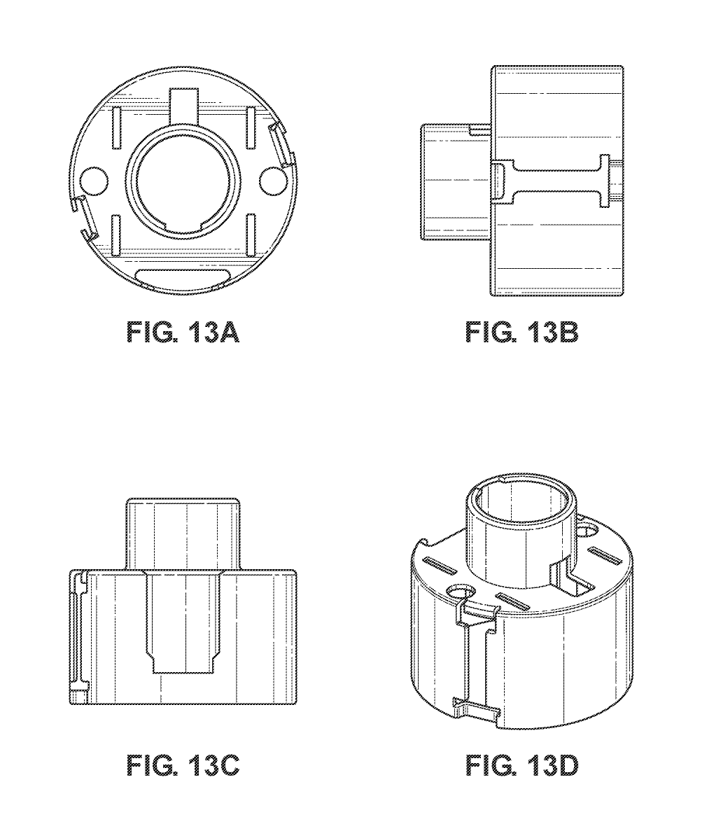

FIGS. 1A-1D illustrate an exploded view of an electronic lock assembly 1000 to be mounted on a door 100 that is mounted onto a door frame 200.

Referring to FIGS. 1A and 1B, the electronic lock 1000 assembly may include an outside assembly 1100, an inside assembly 1200, and a latch assembly 1300.

The outside assembly 1100, the inside assembly 1200, and the latch assembly 1300 may all be secured to the door 100. The outside assembly 1100 may also be secured to the latch assembly 1300 to allow the latch assembly 1300 to be locked and/or unlocked with respect to a strike plate 210 mounted to the door frame 200.

The outside assembly 1100 may include a lock chassis 1110, a face plate 1120, a printed circuit board (PCB) 1130, a cable 1140, back plate securing screw holes 1151 and 1152, a rubber gasket 1160, and a door lever 1170.

The lock chassis 1110 may include chassis-securing screw holes 1111 and 1112, a chassis sleeve 1113, a latch engaging portion 1114, a raceway 1115, and a raceway cover (a.k.a., latching cover) 1116.

The latch engaging portion 1114 may engage with an aperture 1310 of the latch assembly 1300, in order to either secure shutting of the door 100 within the door frame 200, or to lock the door 100 within the door frame 200.

The raceway 1115 may be located at a top portion or a bottom portion of the lock chassis 1110, based on whether a user would like the door to be left-handed or right-handed, but is not limited thereto.

The raceway cover 1116 may be separable from the raceway 1115, or may be attached to a portion of the raceway 1115 using hinges or other connectors (not illustrated).

The face plate 1120 may include a card reader, a radio frequency identification (RFID) reader, a near field communication reader, a BLUETOOTH device, a near field communication (NFC) device, a keypad, a touch pad, and a sensor, but is not limited thereto. For example, if the face plate 1120 is implemented as the radio frequency identification reader, a card with an RFID chip may be brought within proximity of the face plate 1120 to allow the PCB 1130 to control the lock chassis 1110 to lock and/or unlock the latch assembly 1300 with respect to the strike plate 210.

The PCB 1130 may include pre-programmed and/or programmable information regarding various security features of the lock, including, but not limited to, authorized user access, locking and/or unlocking criteria, and emergency settings.

The cable 1140 may be connected at a first end to the PCB 1130, and may include a male connector 1141 at a second end.

The inside assembly 1200 may include a back plate 1210, a printed circuit board (PCB) 1220, a rose liner 1230, chassis-securing screw holes 1241 and 1242, chassis-securing screws 1243 and 1244, an interior trim 1250, a battery cover 1260, and a door lever 1270.

The back plate 1210 may include back plate securing screw holes 1211 and 1212, back plate securing screws 1213 and 1214, chassis-securing screw holes 1215b and 1215b, at least one cable hole 1216, interior trim securing screw holes 1217 and 1218, and a chassis sleeve hole 1219.

The back plate 1210 may be secured to the door 100 by screwing the back plate securing screws 1213 and 1214 into the back plate securing screw holes 1211 and 1212, and then into the back plate securing screw holes 1151 and 1152 of the outside assembly 1100, respectively.

The PCB 1220 may include pre-programmed and/or programmable information regarding various security features of the lock, including, but not limited to, authorized user access, locking and/or unlocking criteria, and emergency settings.

The PCB 1220 may include a female connector 1221 to couple with the male connector 1141.

The rose liner 1230 may include a chassis sleeve hole 1231, at least one cable hole 1232, chassis-securing screw holes 1233 and 1234, and at least one cable hole 1235. The chassis-securing screw holes 1233 and 1234 may correspond to the chassis-securing screw holes 1215a and 1215b of the back plate 1210, and the chassis-securing screw holes 1241 and 1242, respectively.

The rose liner 1230 may be secured to the back plate 1210 by screwing the chassis-securing screws 1243 and 1244 into the chassis-securing screw holes 1233 and 1234 of the rose liner 1230, then into the chassis-securing screw holes 1215a and 1215b of the back plate 1210, then into the chassis-securing screw holes 1241 and 1242, and then into the chassis-securing screw holes 1111 and 1112 of the lock chassis 1110, respectively. As a result, the outside assembly 1100 may be secured to the door 100 simultaneously with the rose liner 1230.

The interior trim 1250 may include interior trim securing screw holes 1251 and 1252, interior trim securing screws 1253 and 1254, a battery holding portion 1255, a battery cover screw hole 1256, a battery cover 1257, a battery cover screw 1258, and a chassis sleeve hole 1259.

The interior trim 1250 may be secured to the back plate 1210 by screwing the interior trim securing screws 1253 and 1254 into the interior trim securing screw holes 1251 and 1252, and then into the interior trim securing screw holes 1217 and 1218, respectively.

The battery holding portion 1255 may include leads connected to the PCB 1220, and may allow batteries to be inserted therein to provide power to the electronic lock 1000.

In order to connect the PCB 1130 of the outside assembly 1000 to the PCB 1220 of the inside assembly 1200, the cable 1140 must be threaded through the hole 110 of the door 100 to allow the male connector 1141 of the cable 1140 to connect to the female connector 1221.

In order to secure the cable 1140 between and within the outside assembly 1000 and the inside assembly 1200, the cable 1140 may be threaded though the raceway 1115. The raceway cover 1116 may be used to cover the cable 1140 within the raceway 1115 in order to secure the cable 1140 within the raceway 1115.

The raceway cover 1116 may be a detachable cover that includes bent side portions that optionally attach to and/or detach from slots along sides of the raceway 1115. Alternatively, the raceway cover 1116 may be a cover attached at a first side thereof to a first side of the raceway 1115 using screws, hinges, or other attachments that allow the cover to function like a door, such that a second side of the raceway cover 1116 can attach to a second side of the raceway 1115 using slots within the second side of the raceway. The attachment of the second side of the raceway cover 1116 is not limited to the aforementioned attachment method, and any other type of attachment devices to detachably secure the second side of the raceway cover 1116 to the second side of the raceway 1115 may be implemented. Furthermore, the raceway cover 1116 may be a non-detachable (i.e., integrated) part of the raceway 1115, such that the cable 1140 is not visible within the raceway from a bird's eye view.

When the cable 1140 is secured within the raceway 1115, the cable 1140 may continue to be threaded through the at least one cable hole 1216 of the back plate 1210, and then through the at least one cable hole cable hole 1235 of the rose liner 1230. Subsequently, the male connector 1141 of the cable 1140 may connect to the female connector 1221 of the PCB 1220 of the inside assembly 1200. Alternatively, the female connector 1221 may be connected directly to the battery holding portion 1255 without the PCB 1220, so that the male connector 1141 of the cable 1140 may connect directly to the battery holding portion 1255.

The battery cover 1257 may be secured to the interior trim 1250 by screwing the battery cover screw 1258 through a through-hole 1257a and into the battery cover screw hole 1256.

When the outside assembly 1100 and the inside assembly 1200 are both secured to the door, the chassis sleeve 1113 is inserted through each of the chassis sleeve hole 1219 of the back plate 1210, the chassis sleeve hole 1231 of the rose liner, and the chassis sleeve hole 1259 of the interior trim 1250, respectively. The rubber gasket 1160 may be optionally slid onto the chassis sleeve 1113 to be disposed between the back plate 1210 and the interior trim 1250.

When the outside assembly 1100 is mounted to the door 100, the door lever 1170 may be attached to an outside portion of the chassis sleeve 1113. When the inside assembly 1200 is mounted to the door 100, the door lever 1270 may be attached to an inside portion of the chassis sleeve 1113.

The door lever door lever 1170 may include a removable core 1271 to allow the door to be lockable. The door lever door lever 1190 may include a removable core 1291 to allow the door to be lockable

The present general inventive concept is not limited to the configuration illustrated herein. More specifically, components of the outside assembly 1100 may be alternatively located within the inside assembly 1200, and components of the inside assembly 1200 may be alternatively located within the outside assembly 1100.

The following is a method of installing an electronic lock assembly 1000. Install the latch in the door. The latch tube prongs should project into the chassis hole. Install the strike plate, checking to make sure that the position of the deadlocking plunger is aligned against the strike plate. Ensure the cable from the exterior board is properly routed through the cylindrical lock chassis. Slide the lock chassis through the chassis hole in the door, ensuring that the chassis engages the latch. Place the back plate on the interior of the door with the upper and lower screws near the chassis. Place the outside rose liner on the interior back plate and screw in, again ensuring the wires are properly fed through the piece. Connect the cables and battery connectors to the interior board. Slide the rubber gasket over the chassis sleeve. Screw the interior trim onto the back plate using the two screws on the right and left of the battery hole. Screw the battery cover onto the trim. Install the levers onto the outside and inside of the door. Install the removable core.

The present general inventive concept can also be embodied as computer-readable codes on a non-transitory computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

A modification to the Chassis body in 2 mirrored locations that allows for the passing of cables and/or wires through a standard cut, solid or hollow core, door. The modification also allows for easy right and left door handing while still being able to pass wires and/or cables through the door. The modification allows the chassis to maintain a grade 1 ANSI rating.

The purpose of the present general inventive concept is to avoid difficult and lengthy installation process of an electronic lock. Most other industry designs require extra holes to be drilled into the door to fish wires through for installation. The present general inventive concept utilizes flex wiring and is pre-installed through the chassis in our factory (manufacturer) so that the end-user simply snaps together two connectors on both sides, and thus, crimping is avoided in the wires. As a result, the present general inventive concept saves time (and money) during installation, simplifies installation to avoid end-user mistakes, and reduces a potential for wires being crimped and damaged.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An electronic door lock assembly, comprising:
an outside assembly attached to a first side of a door;
an inside assembly attached to a second side of a door;
a cable to electrically connect the outside assembly to the inside assembly; and
a raceway to secure the cable to the outside assembly.

2. The electronic door lock assembly of claim 1, wherein the outside assembly comprises:
a lock chassis including the raceway, wherein the lock chassis is disposed within at least a portion of a hole in the door;
a face plate comprising a proximity reader device, wherein the face plate is disposed at the first side of the door; and
a printed circuit board (PCB) disposed between the face plate and the lock chassis.

3. The electronic door lock assembly of claim 2, further comprising:
a latch assembly of lock and/or lock the door, wherein the PCB controls the lock chassis to lock and/or lock the latch assembly in response to the proximity reader device reading an object in proximity thereof.

4. The electronic door lock assembly of claim 2, wherein the inside assembly further comprises:
a back plate disposed at the second side of the door; and
a printed circuit board (PCB) disposed between the back plate and the second side of the door.

5. The electronic door lock assembly of claim 4, wherein:
the cable is connected to the PCB of the outside assembly at a first end of the cable, and
the cable is connected to the PCB of the inside assembly at a second end of the cable.

6. The electronic door lock assembly of claim 5, wherein a first portion of the cable is detachable from a second portion of the cable at a substantially center portion of the cable.

7. The electronic door lock assembly of claim 4, wherein:
the PCB of the outside assembly is connected to a first end of the cable such that a second end of the cable comprises one of a female connector and a male connector, and
the PCB of the inside assembly is connected to the second end of the cable with another one of the male connector and the female connector.

8. The electronic door lock assembly of claim 4, wherein the PCB of the inside assembly includes pre-programmed and/or programmable information regarding various security features of the lock.

9. The electronic door lock assembly of claim 8, wherein the various security features of the lock comprises at least one of authorized user access, locking and/or unlocking criteria, and emergency settings.

10. The electronic door lock assembly of claim 1, further comprising:
a raceway cover to enclose at least a portion of the cable within the raceway.

11. The electronic door lock assembly of claim 10, wherein the raceway cover is separable from the raceway.

12. The electronic door lock assembly of claim 11, wherein the raceway cover is attached to a portion of the raceway at least one of hinges and other connectors.
